(19) United States
(12) Patent Application Publication
(10) Pub. No.: US 2026/0230305 A1
(43) Pub. Date: Aug. 6, 2026

(54) SECURE PAYLOAD AUTHENTICATION

(71) Applicant: International Business Machines Corporation, Armonk, NY (US)

(72) Inventors: James McConnell, Ottawa (CA); TROY E FISHER, Phoenixville, PA (US); Andrew Low, Stittsville (CA)

(73) Assignee: International Business Machines Corporation, Armonk, NY (US)

(21) Appl. No.: 19/045,785

(22) Filed: Feb. 5, 2025

(51) Int. Cl. H04L 9/08; H04L 9/32

(52) U.S. Cl. CPC H04L 9/0825; H04L 9/3247

(57) ABSTRACT

An embodiment generates a key pair, the key pair including a public key and a private key. The embodiment registers the public key in a secure key registry. The embodiment generates a payload. The embodiment digitally signs the payload with the private key creating a secure payload. The embodiment detects the secure payload by a target system. The embodiment validates the secure payload using the public key registered in the secure key registry. The embodiment executes, upon validation of the secure payload, the secure payload over the target system.

### BACKGROUND

The present invention relates generally to computer security. More particularly, the present invention relates to a method, system, and computer program for secure payload authentication.

Penetration testing is a cybersecurity practice that involves simulating a cyberattack on a target system to identify and exploit potential security vulnerabilities. Penetration testing is conducted by an authorized professional employing a systematic approach to assess the effectiveness of a system or organization's security controls. By emulating techniques of malicious actors, penetration testers can uncover weaknesses in systems, networks, and applications that could be exploited by cybercriminals. Through a combination of comprehensive testing, reporting, and/or recommendations, penetration testing provides proactive risks mitigation.

A digital signature is a cryptographic technique used to verify the authenticity, integrity, and non-repudiation of digital data. Digital signatures are enabled by the use of asymmetric cryptography. Accordingly, pair of cryptographic keys is generated: a private key and a public key. When a sender wants to digitally sign a document or message, the sender uses their private key to create a unique digital signature. To verify the digital signature, the recipient uses the sender's public key, which may be publicly available. The recipient applies the public key to the digital signature, which decrypts the signature and produces a hash value. The recipient then computes a new hash value from the received data. If the two hash values match, it confirms that the data has not been altered since it was signed and that the signature was created using the private key corresponding to the public key used for verification.

### SUMMARY

The illustrative embodiments provide secure payload authentication. An embodiment includes generating a payload. The embodiment also includes generating a key pair, the key pair including a public key and a private key. The embodiment also includes registering the public key in a secure key registry. The embodiment also includes digitally signing the payload with the private key creating a secure payload. The embodiment also includes detecting the secure payload by a target system. The embodiment also includes validating the secure payload using the public key registered in the secure key registry. The embodiment also includes executing, upon validation of the secure payload, the secure payload over the target system.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of an example computing environment in accordance with an illustrative embodiment;

FIG. 2 depicts a block diagram of an example computing environment in accordance with an illustrative embodiment;

FIG. 3 depicts a block diagram of an example payload management software module in accordance with an illustrative embodiment;

FIG. 4 depicts a block diagram of an example system architecture in accordance with an illustrative embodiment;

FIG. 5 depicts a flow chart of a process for payload authentication in accordance with an illustrative embodiment;

FIG. 6 depicts a flow chart of an example validation process in accordance with an illustrative embodiment; and

FIG. 7 depicts a flow chart of an example process for secure payload authorization.

### DETAILED DESCRIPTION

Currently, in the realm of cybersecurity, there is a significant challenge in differentiating a payload from an authorized penetration tester versus a malicious attack from a malicious actor. This challenge arises due to the lack of robust authentication and authorization mechanisms in place to distinguish between legitimate penetration testing activities and actual malicious attacks.

One reason for this difficulty is because traditional security measures do not provide sufficient context or validation of the source of the payload. Without a reliable way to verify the identity and intentions of the sender, security systems often treat all incoming payloads as potential threats, regardless of whether they originate from an authorized penetration tester or a malicious actor.

Moreover, the lack of comprehensive key management and validation processes further exacerbates this issue. In the absence of a secure and centralized system for registering and managing public keys, there is no way for a target system to confirm the authenticity of the sender and the integrity of the payload. Furthermore, the limitations of existing security software often lack the sophistication to distinguish between benign testing actions and genuine security threats, leading to false positives and unnecessary alerts.

Additionally, the absence of approval workflows and logging mechanisms makes it challenging to track and monitor the activities of penetration testers effectively. Without a clear audit trail of approved actions and logged events, security teams struggle to differentiate between legitimate testing activities and unauthorized intrusions.

Even further, flagging authorized payloads from penetration testers as potentially malicious by security systems leads to unnecessary wastage of computer resources. Accordingly, by mistakenly identifying legitimate testing payloads as malicious threat actions may result in unnecessary triggering of alerts, consumption of processing power, as well as diverts attention towards investigating false positives. This misallocation of resources not only impacts system performance and efficiency but also increases the risk of overlooking genuine security threats amidst the influx of false alarms. Accordingly, false flagging authorized payloads can result in decreased system responsiveness, heightened operational costs, and diminished effectiveness in detecting and responding to actual security incidents.

Accordingly, the current cybersecurity landscape suffers from a lack of penetration testing authentication, authorization, and validation mechanisms, making it challenging to differentiate a payload from an authorized penetration tester versus a malicious attack from a malicious actor. Addressing these shortcomings requires the implementation of a comprehensive system that incorporates secure key management, approval workflows, logging mechanisms, and automated identification capabilities to enhance the security posture and effectively mitigate the risks associated with unauthorized activities.

In an embodiment, a testing management mechanism of a cybersecurity system includes a mechanism to validate actors attempting to execute payloads over a target system to enable authorized actors to perform penetration tests. By implementing a validation mechanism, the system can differentiate between legitimate penetration testers and malicious actors, thereby enhancing security and reducing the risk of unauthorized activities, as well as reducing unnecessary expenditure of computer resources.

One advantage of the validation mechanism includes the ability to authenticate the identity of the actors executing payloads on the target system. By requiring an actor to register a public key and undergo a validation process, the system can verify the legitimacy of the sender and ensure that only authorized actors are allowed to perform penetration tests. This authentication step adds an additional layer of security and helps prevent unauthorized access to the target system.

Furthermore, a validation mechanism can enforce restrictions on the activities that authorized actors can perform during penetration testing. By defining specific criteria such as duration, allowed source/destination IPs, and permitted actions, the system can ensure that penetration testers adhere to predefined guidelines and do not engage in unauthorized malicious activities. Moreover, the validation mechanism can facilitate the revocation of access for actors who violate the established rules or engage in unauthorized activities. By monitoring and auditing the actions of penetration testers, the system can quickly identify any suspicious behavior and take appropriate measures to revoke access and prevent further harm to the target system. This proactive approach to security helps maintain the integrity of the system and safeguards against potential threats.

As used throughout the present disclosure, the term “penetration tester” (or simply “pen tester”) refers to an actor authorized to simulate cyberattacks on computer systems, networks, or applications to identify security vulnerabilities and assess the effectiveness of existing security measures.

As used throughout the present disclosure, the term “payload” refers to actual data or content that is transmitted or executed as part of a communication or operation. In the context of penetration testing, a payload may include malicious code, commands, or actions that are designed to exploit vulnerabilities in a target system. The payload is often used to simulate cyberattacks and assess the security posture of a system by demonstrating the potential impact of a successful exploit. Payloads can include various forms of data, such as scripts, executables, shellcode, or other types of malicious content, that are delivered to a target system to achieve a specific objective, such as gaining unauthorized access, escalating privileges, or exfiltrating sensitive information.

As used throughout the present disclosure, the term “test case” refers to a specific scenario or set of conditions that is designed to evaluate the security of a system, network, or application. A test case outlines the steps, inputs, expected outcomes, and success criteria for conducting a controlled experiment to assess the effectiveness of security controls, identify vulnerabilities, or validate the resilience of the system against potential threats. Test cases in cybersecurity are structured, systematic, and reproducible procedures that aim to simulate real-world attack scenarios, security incidents, or misuse cases to validate the security posture of the target environment. By defining test cases, cybersecurity professionals can methodically assess the security controls, detect weaknesses, and verify the effectiveness of security measures in protecting against cyber threats.

As used throughout the present disclosure, the term “digital signature” refers to a cryptographic technique used to verify the authenticity, integrity, and non-repudiation of digital data. Using a digital key requires creating private key, a unique digital fingerprint of the data, which can only be decrypted and verified using the corresponding public key. The digital signature provides assurance that the data has not been altered or tampered with during transmission and that it was indeed signed by the entity possessing the private key. Digital signatures may be employed in cybersecurity to authenticate the origin of electronic messages, documents, transactions, and other data.

Illustrative embodiments provide for using a digital signature to authorize the identity of a penetration tester. When a penetration tester signs a payload or action using their private key, a unique digital signature is generated. This digital signature serves as cryptographic proof that the action originated from the penetration tester who possesses the corresponding private key. To verify the identity of the penetration tester, the recipient target system of the signed payload can use the tester's public key to decrypt and validate the digital signature. If the decrypted signature matches the original data, the target system confirms that the action was indeed signed by the penetration tester using their private key. This process establishes the authenticity and identity of the penetration tester, as only the individual possessing the private key can generate a valid digital signature. By utilizing digital signatures in this manner, systems and organizations can securely authorize the identity of penetration testers and validate the legitimacy of actions performed during penetration testing activities, enhancing trust and accountability in the testing process.

Illustrative embodiments provide for establishing and maintaining a registry for public keys belonging to authorized penetration testers. Each penetration tester's public key is registered in the system's registry along with relevant metadata, such as the tester's identity, associated restrictions, and expiration dates. By centralizing the management of public keys, the system can streamline the process of decrypting digital signatures associated with payloads and verify the authenticity of actions performed by penetration testers.

Illustrative embodiments may leverage a digital signature component to decrypt digital signatures associated with payloads of penetration testers using the public keys stored in the registry. When a penetration tester signs a payload with their private key, a digital signature is generated. The digital signature component retrieves the corresponding public key from the registry and applies it to the digital signature to decrypt and verify the authenticity of the payload. By comparing the decrypted signature with the payload data, the system can confirm that the payload was indeed signed by an authorized penetration tester. This verification process ensures the integrity and origin of the actions performed by penetration testers.

In an embodiment, the key registering process involves penetration testers registering their public keys in a centralized registry within the security system. Each public key is associated with the identity of the penetration tester and may include metadata specifying any restrictions or permissions related to the key. This registration process enables the security system to authenticate the origin of digital signatures associated with payloads generated by penetration testers. By verifying the digital signatures using the corresponding public keys stored in the registry, the system can confirm the legitimacy of the actions performed and prevent unauthorized actors from masquerading as authorized testers.

Furthermore, the digital signature authorization process ensures that only specified actions signed by authorized penetration testers are approved and executed on the target system. By integrating key registering and digital signature authorization mechanisms into existing security systems, organizations can establish a secure and reliable framework for conducting penetration tests without triggering unintended security responses. This approach enhances the accuracy and effectiveness of security measures by ensuring that only authorized actions are permitted, reducing the risk of false alarms and enabling penetration testers to assess the target system's vulnerabilities without interference from automated security controls.

Illustrative embodiments further provide for additional metadata that may be used to validate a payload from an authorized penetration tester. For example, metadata time or duration related metadata may be used to specify the time period during which the penetration tester's public key is valid for signing actions. By enforcing a duration restriction, the security system can control the temporal scope of the tester's authorization, ensuring that only actions signed within the designated timeframe are considered valid. This type of metadata-based restriction may prevent unauthorized use of outdated keys and enhances the overall security of the system by limiting the window of opportunity for potential misuse.

In an embodiment, another type of additional metadata that can be utilized includes source or destination IP based metadata. This metadata may define the specific source and destination IP addresses from which the penetration tester is authorized to perform actions. By restricting the allowed IP addresses, the security system can validate the origin and destination of the payloads signed by the tester, ensuring that actions are only executed from approved locations. This restriction enhances the system's security posture by preventing unauthorized access from unapproved IP addresses and mitigating the risk of malicious actors attempting to exploit vulnerabilities from unauthorized locations.

In an embodiment, another type of additional metadata that may be employed is the activity restriction metadata that outlines the specific types of activities or commands that the penetration tester is permitted to perform on the target system. By defining activity restrictions, the security system can validate the legitimacy of the actions signed by the tester and prevent unauthorized or potentially harmful activities from being executed. This granular control over the permitted actions enhances the system's security by ensuring that only authorized testing activities are conducted, reducing the risk of unintended consequences or malicious exploitation of vulnerabilities during penetration testing.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

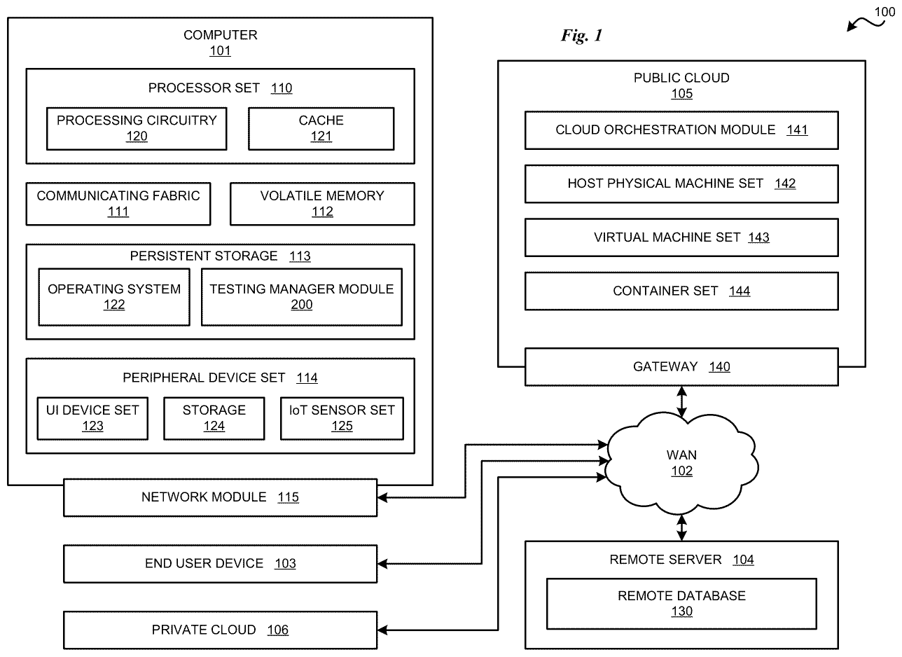

With reference to FIG. 1, this figure depicts a block diagram of a computing environment 100. Computing environment 100 contains an example of an environment for the execution of at least some of the computer code involved in performing the inventive methods, such as a testing manager module 200 may be configured to authenticate the origin of secure payloads from authorized penetration testers. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

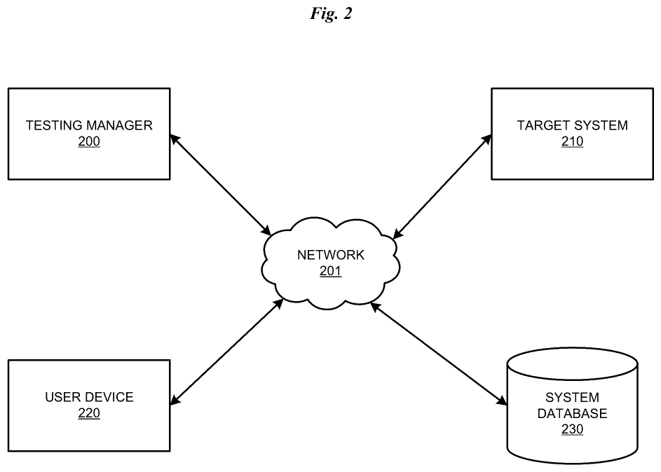

With reference to FIG. 2, this figure depicts a block diagram of an example computing environment in accordance with an illustrative embodiment. In the illustrated embodiment, the computing environment includes the testing manager 200 of FIG. 1.

In an embodiment, the testing manager 200 is configured for authenticating identity of payloads from authorized actors. In an embodiment, testing manager 200 coordinates and manages the penetration testing activities conducted on the target system 210. In an embodiment, testing manager 200 interacts with the network 201 to facilitate communication between the user device 220, where penetration testers initiate testing activities, and the target system 210, which is the system being assessed for security vulnerabilities. The network 201 acts as the communication infrastructure that enables data exchange between the user device 220, testing manager module 200, and the target system 210.

In an embodiment, the user device 220 includes an interface through a penetration tester can interact with the testing manager module 200 to define test cases, generate payloads, and initiate testing activities on the target system 210. In some embodiments, a penetration tester defines test cases, generates payloads and conducts all of the testing activities from their own workstation such as user device 220. In some other embodiments, testing manager module 200 may provide a platform to define test cases, generate payloads, and initiate testing activities. In an embodiment, a penetration tester uses the user device 220 to access the testing manager module 200, input testing parameters, and/or monitor the progress of the penetration testing process. In an embodiment, the user device 220 serves as the endpoint from which authorized testers launch simulated attacks, sign actions with digital signatures, and execute test cases against the target system 210.

In an embodiment, system database 230 is configured for storing and managing data related to the penetration testing activities, including test cases, payloads, digital signatures, and results of the testing process. In an embodiment, the system database 230 serves as a repository for storing information generated during the penetration testing activities. In an embodiment, the testing manager 200 interacts with the system database 230 to retrieve and store relevant information, ensuring that aspects of the testing process are documented and associated data are securely managed throughout the testing lifecycle.

In an embodiment, user device 220 is configured to employ a generation process includes that includes creating a secure private key that is kept confidential and a corresponding public key that can be shared with others for verification purposes. Generating a key pair for digitally signing payloads may include employing one or more to known cryptographic tools and software that facilitate key generation. For example, the penetration tester can use user device 220 to generate a public-private key pair using cryptographic algorithms such as RSA or ECC.

In an embodiment, the testing manager 200 maintains a registry of public keys by storing the public keys of authorized penetration testers in a centralized repository. When a penetration tester generates a key pair on the user device 220, the public key is securely transmitted to the testing manager 200 for registration. The testing manager 200 stores the public key in a key registry, along with associated metadata such as the tester's identity, restrictions, and expiration dates. By maintaining this registry, the testing manager 200 can authenticate the origin of actions signed by penetration testers using their public keys. This registry ensures that only authorized testers can sign payloads and perform testing activities, enhancing the security and integrity of the penetration testing process.

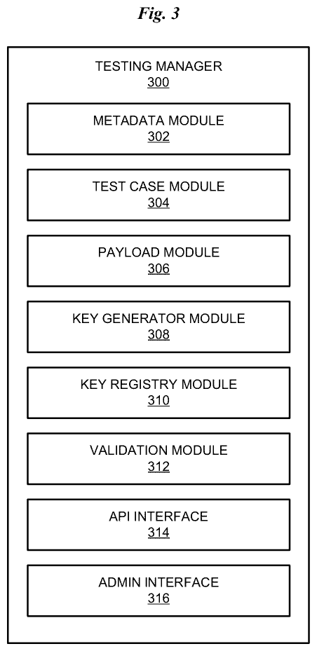

With reference to FIG. 3, this figure depicts a block diagram of an example testing manager module in accordance with an illustrative embodiment. In an embodiment, the testing manager module 300 includes a software module comprising a plurality of other connected software modules. In an embodiment, the testing manager module 300 includes metadata module 302, a test case module 304, a payload module 306, key generation module 308, key registry module 310, and validation module 312.

In alternative embodiments, testing manager module 300 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications. In some embodiments, testing manager 300 comprises specialized hardware, such as for example, an Application-Specific Integrated Circuit (ASIC) or Field-Programmable Gate Array (FPGA) for accelerated processing of specific tasks, routines, algorithms, training operations, etc. In some embodiments, embodiments of the testing manager 300 may include a combination of physical and virtualized components, as well as may be partially or entirely virtualized on a virtual machine.

In an embodiment, the metadata module 302 may be configured to store and manage metadata related to the penetration testing actors, payloads, penetration tests, and/or penetration testing related activities. In an embodiment, the metadata module 302 creates information such as duration restrictions, source/destination IP restrictions, and activity restrictions to ensure that all relevant testing parameters and constraints are documented and utilized effectively throughout the testing process.

In an embodiment, the test case module 304 may be configured to define and organize the specific test cases that will be executed during the penetration testing process. This module outlines the objectives, methodologies, and procedures for conducting the tests, ensuring that the testing activities are structured, systematic, and aligned with the organization's security objectives.

In an embodiment, the test case module 304 can leverage the metadata module 302 to incorporate specific metadata elements that provide context, constraints, and additional criteria for the testing activities. For example, the test case module 304 may define a test case that simulates a specific attack scenario and requires certain duration restrictions or source IP restrictions to be applied. In such cases, the test case module 304 can interact with the metadata module 302 to access and include the necessary metadata elements in the test case definition.

In an embodiment, the payload module 306 may be configured to generate, store, and/or manage the payloads used in the penetration testing activities. This module facilitates the creation of simulated attack scenarios, including malicious payloads, to assess the security posture of the target system. To ensure the authenticity and integrity of the payload during transmission and execution, the penetration tester utilizes their private key to digitally sign the payload. This process involves creating a unique digital signature for the payload using the private key, which is kept confidential. The digital signature, generated through a cryptographic algorithm, serves as a cryptographic proof of the payload's origin and integrity.

In an embodiment, once the digital signature is attached to the payload, forming a signed payload package, the recipient can verify its authenticity by using the corresponding public key associated with the private key used for signing. The public key, which may be stored in a key registry, is used to decrypt and validate the digital signature. By validating the digital signature, the recipient can confirm that the payload was signed by the authorized penetration tester using their private key, ensuring the security and trustworthiness of the payload throughout the penetration testing process.

In an embodiment, the key generation module 308 may be configured to generate cryptographic keys, including public and private key pairs, for signing and verifying actions during the penetration testing process. This module ensures the secure creation of keys unique to each penetration tester, enabling secure communication and validation of actions performed by authorized testers.

In an embodiment, the key registry module 310 may be configured to serve as a repository for storing and managing the public keys of authorized penetration testers. This module maintains a record of registered public keys, along with associated metadata and restrictions, to validate the authenticity of actions signed by testers. The key registry module 310 authenticates the origin of actions and ensures that only authorized testers can perform penetration testing activities.

In an embodiment, key registry module 310 defines a mapping between public keys and a set of permissible actions for penetration testing activities. This module serves as a centralized repository for storing public keys associated with authorized penetration testers and their corresponding permissions and constraints. By maintaining this mapping, the key registry module 310 establishes a link between the identity of the penetration tester, their public key, and the actions they are permitted to execute during testing.

In an embodiment, when a penetration tester registers their public key in the key registry module 310, the module captures and stores information about the tester's identity, permissions, and constraints. This information defines the scope of permissible actions that the penetration tester is authorized to perform during penetration testing activities. In an embodiment, the key registry module 310 facilitates the implementation of fine-grained permissions and restrictions, allowing administrators of existing security systems to tailor access rights and define the scope of activities permitted for each penetration tester based on their public key registration.

In an embodiment, the validation module 312 may be configured to verify the authenticity of actions performed by penetration testers during the testing process. This module uses the registered public keys from the key registry module 310 to validate digital signatures associated with the actions, ensuring that only authorized and legitimate activities are executed on the target system.

In an embodiment, when a penetration tester signs a payload with their private key, a digital signature is created to authenticate the origin of the action. The validation module 312 retrieves the corresponding public key from the key registry module, which stores the public keys of authorized penetration testers along with associated metadata and permissions. By accessing the key registry module, the validation module 312 can decrypt and verify the digital signature using the public key associated with the penetration tester who signed the payload.

During the validation process, the validation module 312 compares the decrypted signature with the payload data to confirm that the payload was signed by an authorized penetration tester using their private key. By cross-referencing the public key from the key registry module, the validation module 312 determines whether the payload is valid and originated from an authorized source. This validation mechanism ensures that only actions signed by authorized penetration testers are considered valid.

In an embodiment, the API interface module 314 facilitates communication and interaction between different modules, systems, or external entities within the cybersecurity system infrastructure. In an embodiment, API interface module 314 provides a standardized interface or set of protocols that allow integration and data exchange between disparate systems, applications, or services. The API Interface Module 314 enables interoperability by defining a structured way for modules to interact with each other, and allows modules to request and exchange data, trigger actions, and receive responses.

In an embodiment, the administrator interface module 316 provides a user interface for system administrators to monitor and adjust settings based on system performance, requirements, goals, and/or other criteria. In an embodiment, the administrator interface module 316 may provide a user interface that allows system administrators to monitor and adjust settings within the cybersecurity system based on various criteria such as system performance, requirements, goals, and security policies. In an embodiment, the administrator interface module 316 provides administrators with a platform to view real-time system metrics, configure parameters, and manage security settings. In an embodiment, the administrator interface module 316 manifests in the form of a as graphical dashboard that displays key performance indicators, alerts, and/or status updates.

In an embodiment, the administrator interface module 316 allows administrators to customize settings related to payload execution permissions based on digital signatures and associated defined constraints. Administrators can define rules and constraints within the interface, such as specifying which penetration testers are authorized to execute payloads, setting restrictions based on digital signatures, and configuring permissions based on predefined criteria. This functionality allows administrators to establish granular control over the execution of payloads, ensuring that only authorized actions are permitted and aligning with defined security policies.

In an embodiment, the administrator interface module 316 allows administrators to define permissions and/or restrictions related to payload execution. In an embodiment, the administrator interface module 316 allows administrators to define a set of conditions for executing a payload. Examples of conditions may include, but are not limited to, IP destination restriction(s), duration restriction(s), test type restriction(s), and/or action type restriction(s).

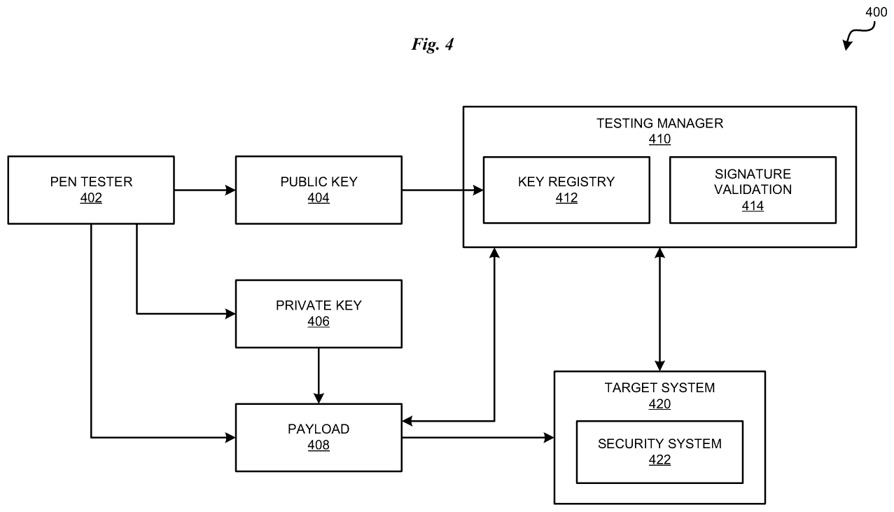

With reference to FIG. 4, this figure depicts a block diagram of an example system architecture in accordance with an illustrative embodiment. In an embodiment, the system 400 includes testing manager 200 of FIGS. 1 and 2 and/or testing manager 300 of FIG. 3.

In an embodiment, penetration tester 402 generates a key-pair including a public key 404 and a private key 406. The public key 404 is stored on key registry 412 of testing manager 410. The private key is used to digitally sign a payload 408 generated by penetration tester 402. The testing manager 410 uses validation mechanism 414 to validate the payload 408 signed by the private key 406. Upon validating the payload 408, the testing manager 410 communicates to security system 422 of target system 420 to allow execution of the payload 408 by penetration tester 402 over target system 420.

In an embodiment, penetration tester 402 generates a key pair, including a public key 404 and a private key 406. Accordingly, the penetration tester 402 initiates the key generation process by creating a public-private key pair, where the public key 404 is intended for sharing and the private key 406 is kept confidential. The public key 404 is then securely stored in the key registry 412 of the testing manager 410, ensuring that it is accessible for verification purposes. Subsequently, when the penetration tester 402 needs to digitally sign a payload 408 generated for testing purposes, they utilize their private key 406 to create a unique digital signature, providing cryptographic proof of the payload's origin and integrity.

Upon signing the payload 408 with the private key 406, the Testing Manager 410 employs the validation mechanism 414 to verify the authenticity and integrity of the signed payload. The validation mechanism 414 decrypts the digital signature using the corresponding public key 404 stored in the key registry 412, confirming that the payload was indeed signed by the authorized penetration tester 402. Once the payload 408 is validated, the Testing Manager 410 communicates with the security system 422 of the target system 420 to authorize the execution of the payload 408 by the penetration tester 402 over the target system 420. This communication ensures that only authenticated and authorized actions are performed on the target system 420, enhancing security and trust in the penetration testing process.

In an embodiment, the validation mechanism 414 may be configured to validate origin and legitimacy of requests to store public key generated to be stored on the public key registry 412. In an embodiment, restrictions and/or permissions may be stored on metadata stored on key registry 412. In some embodiments, validation mechanism 414 verifies whether request to store key in key registry occurred at right time, from right destination, consists of the right actions, etc. In some embodiments, validation mechanism 414 verifies whether request to execute payloads occurred at right from, from right destination, is comprised of the right actions, etc.

In an embodiment, when a request is made to store a public key in the key registry 412, the validation module 414 determines that the request occurs at the right time, originates from the correct source, and includes the appropriate actions specified in the request. By validating these parameters, the validation mechanism 414 confirms that the public key storage request aligns with the defined constraints and permissions.

In an embodiment, when a request is made to execute payloads, the validation mechanism 414 verifies the request's origin, destination, and actions to ensure that it complies with the established criteria. The validation mechanism 414 determines whether the request to execute payloads is initiated from the correct source, directed to the appropriate destination, and consists of the authorized actions specified for the penetration testing activities. By validating these aspects, the validation mechanism 414 confirms that the request to execute payloads adheres to the defined restrictions and permissions.

In an embodiment, payload actions may include identifying metadata that specifies the type of payload action to be executed, providing information about the characteristics, nature and/or purpose of the action. When a payload is signed by an authorized penetration tester, the digital signature of the tester may be embedded in the XML comment of the payload action data file. This approach enables associating the digital signature with the payload data without interfering with the execution of the payload action. By storing the digital signature in the XML comment, the integrity and authenticity of the payload action can be verified without disrupting the execution process.

In an embodiment, a wrapper script may be utilized for executables for validation of the execution process. In an embodiment, the wrapper script signs the executable process using the digital signature of the authorized penetration tester before initiating the execution of the process. This signing mechanism provides that the process is authenticated and authorized by the penetration tester and may be validated by validation mechanism 414. By incorporating a wrapper script for executables that signs the process, embodiments provide securitization, validation and verification of actions performed during penetration testing activities.

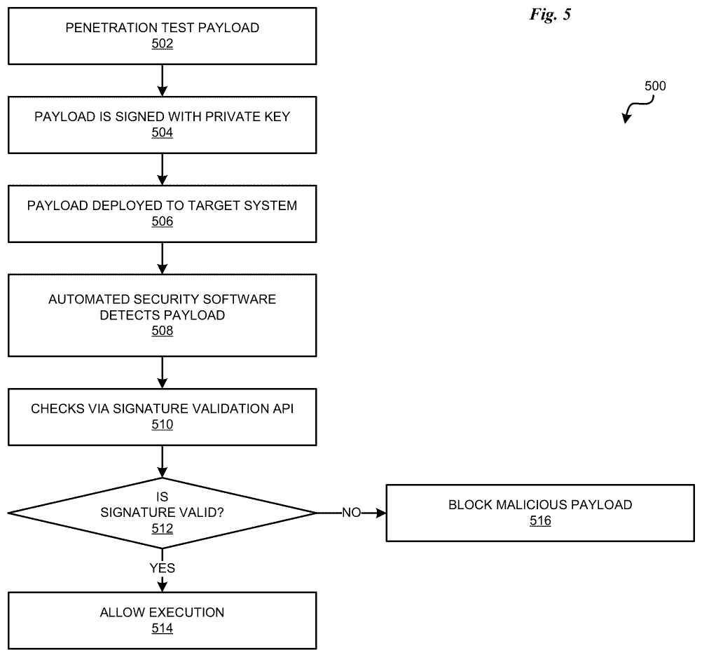

With reference to FIG. 5, this figure depicts a flowchart of an example process of payload authentication, in accordance with an illustrative embodiment. In an embodiment, the testing manager 200 of FIGS. 1 and 2 and/or testing manager 300 of FIG. 3 carries out some or all of the process 500.

In an embodiment, at step 502, the process generates a payload. In an embodiment, at step 504, the process signs the payload with a private key. In an embodiment, at step 506, the process deploys the payload to a target system. In an embodiment, at step 508, the process detects, via automated security system software, the payload. In an embodiment, at step 510, the process checks the signature of the payload. In an embodiment, at step 512, the process determines whether the signature is valid. In an embodiment, at step 514, upon a determination that the signature is valid, the process allows execution of the payload of the target system. In an embodiment, at step 516, upon a determination that the signature is not valid, the process blocks the potentially malicious payload.

In an embodiment, the security system detects the digital signature embedded in the payload, which serves as a cryptographic validation of the payload's origin. The system validates the signature by decrypting the signature with the corresponding public key of the authorized penetration tester, confirming the tester's authorization. The metadata associated with the payload is then checked to ensure compliance with defined constraints, such as for example, test type, test tags as defined by a tagging system, and specific key usage restrictions. The system verifies that the payload originates from the correct IP address, is executed within the designated validity period, and records the test type in the metadata for clarity. In some embodiments, the process includes implementing a single-use signature approach, so that once a signature is used and validated, any attempt to reuse the key triggers a security incident alert, preventing unauthorized key reuse and enhancing the overall security of the testing process.

The process offers several benefits, including automated bypass of Extended Detection and Response (XDR) and automated security systems, which reduces interference during penetration testing and prevents unintentional testing of the firewall. By automatically bypassing XDR and automated security systems, the testing process can proceed without triggering unnecessary alerts or disruptions, allowing testers to focus on identifying vulnerabilities without inadvertently triggering security measures meant for real threats.

Additionally, the process provides automatic identification for the Security Operations Center (SOC), enabling SOC teams to spend less time and resources resolving false positives. By automatically identifying and distinguishing legitimate testing activities from genuine security threats, the SOC can allocate resources more efficiently, prioritize actual security incidents, and reduce the time spent investigating and addressing false alarms. This streamlined identification process enhances the SOC's effectiveness in responding to real security incidents and minimizes the impact of false positives on operational efficiency.

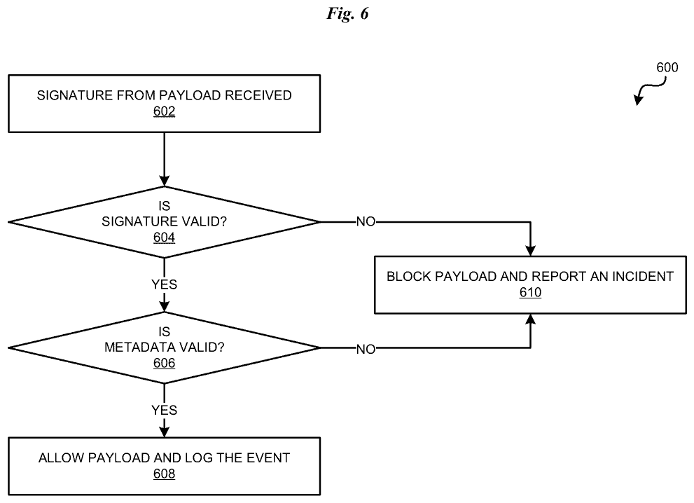

With reference to FIG. 6, this figure depicts example process for dynamic computer resource allocation optimization in accordance with an illustrative embodiment. In an embodiment, the testing manager 200 of FIGS. 1 and 2 and/or testing manager 300 of FIG. 3, carries out some or all of process 600.

In an embodiment, at step 602, the process receives a signature from a payload. In an embodiment, at step 604, the process determines whether the signature of the payload is valid. In an embodiment, at step 606, upon a determination that the signature is valid, the process determines whether metadata of the payload is valid. In an embodiment, at step 610, upon a determination that the signature is not valid, the process blocks the payload and reports a security incident to a relevant stakeholder. In an embodiment, at step 608, upon a determination that the metadata is valid, the process allows the execution of the payload and logs the event.

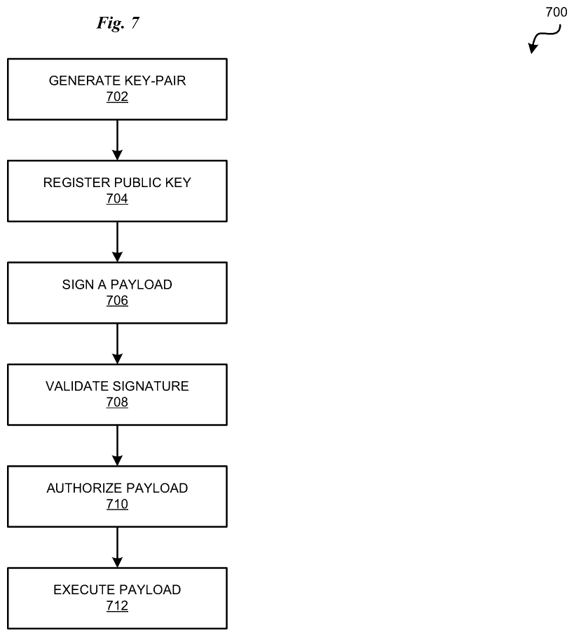

With reference to FIG. 7, this figure depicts an example process for dynamic computer resource allocation optimization in accordance with an illustrative embodiment. In an embodiment, the testing manager 200 of FIGS. 1 and 2 and/or testing manager 300 of FIG. 3, carries out some or all of process 700.

In an embodiment, at step 702, the process generates a key-pair. In an embodiment, the key-pair includes a public key and a private key. In an embodiment, at step 704, the process registers the public key in a public key registry. In an embodiment, the public key registry is maintained by testing manager module software mechanism accessible via API. In an embodiment, at step 706, the process signs a payload originating from an actor. In an embodiment, at step 708, the process validates the signature of the payload to identify the actor. In an embodiment, at step 710, the process authorizes execution of the payload from the identified actor. In an embodiment, at step 712, the process executes the secure payload over a target system.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
generating a key pair, the key pair including a public key and a private key;
registering the public key in a secure key registry;
generating a payload;
digitally signing the payload with the private key creating a secure payload;
detecting the secure payload by a target system;
validating the secure payload using the public key registered in the secure key registry; and
executing, upon validation of the secure payload, the secure payload over the target system.

2. The computer-implemented method of claim 1, further comprising defining a set of conditions for executing the payload.

3. The computer-implemented method of claim 2, wherein the set of conditions comprises an IP destination restriction.

4. The computer-implemented method of claim 2, wherein the set of conditions comprises a duration restriction.

5. The computer-implemented method of claim 2, wherein the set of conditions comprises a test type restriction.

6. The computer-implemented method of claim 2, wherein the set of conditions comprises an action type restriction.

7. A computer program product comprising one or more computer readable storage media, and program instructions collectively stored on the one or more computer readable storage media, the program instructions executable by a processor to cause the processor to perform operations comprising:
generating a key pair, the key pair including a public key and a private key;
registering the public key in a secure key registry;
generating a payload;
digitally signing the payload with the private key creating a secure payload;
detecting the secure payload by a target system;
validating the secure payload using the public key registered in the secure key registry; and
executing, upon validation of the secure payload, the secure payload over the target system.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, further comprising defining a set of conditions for executing the payload.

11. The computer program product of claim 10, wherein the set of conditions comprises an IP destination restriction.

12. The computer program product of claim 10, wherein the set of conditions comprises a duration restriction.

13. The computer program product of claim 10, wherein the set of conditions comprises a test type restriction.

14. The computer program product of claim 10, wherein the set of conditions comprises an action type restriction.

15. A computer system comprising a processor and one or more computer readable storage media, and program instructions collectively stored on the one or more computer readable storage media, the program instructions executable by the processor to cause the processor to perform operations comprising:
generating a key pair, the key pair including a public key and a private key;
registering the public key in a secure key registry;
generating a payload;
digitally signing the payload with the private key creating a secure payload;
detecting the secure payload by a target system;
validating the secure payload using the public key registered in the secure key registry; and
executing, upon validation of the secure payload, the secure payload over the target system.

16. The computer system of claim 15, further comprising defining a set of conditions for executing the payload.

17. The computer system of claim 16, wherein the set of conditions comprises an IP destination restriction.

18. The computer system of claim 16, wherein the set of conditions comprises a duration restriction.

19. The computer system of claim 16, wherein the set of conditions comprises a test type restriction.

20. The computer system of claim 16, wherein the set of conditions comprises an action type restriction.
